(19) United States
(12) Patent Application Publication
(10) Pub. No.: US 2025/0103875 A1
(43) Pub. Date: Mar. 27, 2025

(54) EFFICIENT TRANSFORMER TRAINING BASED ON SMALLER PRETRAINED MODELS

(71) Applicants: International Business Machines Corporation, Armonk, NY (US); Massachusetts Institute of Technology, Cambridge, MA (US)

(72) Inventors: Rameswar Panda, Medford, MA (US); Peihao Wang, Austin, TX (US); LEONID KARLINSKY, Acton, MA (US); Rogerio Schmidt Feris, West Hartford, CT (US); David Cox, Somerville, MA (US); Yoon Hyung Kim, Cambridge, MA (US)

(21) Appl. No.: 18/372,661

(22) Filed: Sep. 25, 2023

(51) Int. Cl. G06N 3/08; G06N 3/0455

(52) U.S. Cl. CPC G06N 3/08; G06N 3/0455

(57) ABSTRACT

Parameters of a first transformer are accessed, and size dimensions of a second transformer that is to be trained and is larger than the first transformer are received. The parameters of the first transformer are linearly transformed using a combination of a width-growth operator and a depth-growth operator, wherein the linear transformation produces a set of new parameters, the set corresponding to the size dimensions of the second transformer. The second transformer is initialized with the set of new parameters.

### STATEMENT REGARDING PRIOR DISCLOSURES BY THE INVENTOR OR A JOINT INVENTOR

The following disclosure is submitted under 35 U.S.C. 102(b)(1)(A):
Wang P, Panda R, Hennigen L T, Greengard P, Karlinsky L, Feris R, Cox D D, Wang Z, Kim Y., Learning to Grow Pretrained Models for Efficient Transformer Training, arXiv preprint arXiv:2303.00980. 2023 Mar. 2.

### BACKGROUND

The present invention relates generally to the electrical, electronic and computer arts and, more particularly, to machine learning and transformers for machine learning.

### SUMMARY

Principles of the invention provide systems and techniques for efficient transformer training based on smaller pretrained models. In one aspect, an exemplary method includes the operations of accessing parameters of a first transformer; receiving size dimensions of a second transformer that is to be trained and is larger than the first transformer; linearly transforming the parameters of the first transformer using a combination of a width-growth operator and a depth-growth operator, wherein the linear transformation produces a set of new parameters, the set corresponding to the size dimensions of the second transformer; and initializing the second transformer with the set of new parameters.

In one aspect, a computer program product comprises one or more tangible computer-readable storage media and program instructions stored on at least one of the one or more tangible computer-readable storage media, the program instructions executable by a processor to cause the processor to perform operations comprising accessing parameters of a first transformer; receiving size dimensions of a second transformer that is to be trained and is larger than the first transformer; linearly transforming the parameters of the first transformer using a combination of a width-growth operator and a depth-growth operator, wherein the linear transformation produces a set of new parameters, the set corresponding to the size dimensions of the second transformer; and initializing the second transformer with the set of new parameters.

In one aspect, an apparatus comprises a memory and at least one processor, coupled to the memory, and operative to perform operations comprising accessing parameters of a first transformer; receiving size dimensions of a second transformer that is to be trained and is larger than the first transformer; linearly transforming the parameters of the first transformer using a combination of a width-growth operator and a depth-growth operator, wherein the linear transformation produces a set of new parameters, the set corresponding to the size dimensions of the second transformer; and initializing the second transformer with the set of new parameters.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a block diagram of the learning to grow (LIGO) framework that accelerates training by using the weights of a smaller model to initialize the weights of the larger model, in accordance with an example embodiment;

FIGS. 2A-C show comparisons between the different baselines for training BERT models, in accordance with example embodiments;

FIGS. 3A-C show results on RoBERTa and the conventional large language model, in accordance with example embodiments;

FIGS. 4A-B show results on a baseline conventional image transformer technique for image classification tasks, in accordance with example embodiments;

FIGS. 5A-C show results of applying learning to grow framework (LIGO) with Orthogonal Training Strategies, in accordance with example embodiments;

FIGS. 6A-B show the results on depth only and width only extension, in accordance with an example embodiment;

FIGS. 7A-C show tables of experimental results, in accordance with example embodiments;

FIG. 8 is an example method for training a larger model using the weights of a smaller model and performing inferencing using the trained larger model, in accordance with an example embodiment;

FIG. 9 is an example method for performing a forward pass using the learning to grow framework, in accordance with an example embodiment; and

FIG. 10 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Scaling transformers has led to significant breakthroughs in many domains, leading to a paradigm in which larger versions of existing models are trained and released on a periodic basis. Conventionally, new instances of such models are typically trained completely from scratch, despite the fact that they are often just scaled-up versions of their smaller counterparts. The implicit knowledge in the parameters of smaller, extant models is conventionally overlooked in enabling the faster training of newer, larger models.

Generally, techniques, systems, and methods are disclosed for accelerating machine learning training, such as transformer training, by learning to grow smaller pretrained models (such as transformers). In one example embodiment, a linear mapping of the parameters of the smaller model is learned for initializing the larger model. For tractable learning, the linear transformation is factorized as a composition of (linear) width- and depth-growth operators, and a Kronecker factorization of these growth operators is further employed to encode architectural knowledge. Experiments across both language and vision transformers demonstrate that the disclosed Learning to Grow (LIGO) approach can save around 50% computational cost of training from scratch, while also consistently outperforming strong baselines that also reuse smaller pretrained models to initialize larger models. References herein to “LIGO” refer to exemplary embodiments thereof, it being understood that other embodiments may have different combinations of features as will be apparent from the appended claims.

The transformer architecture has emerged as a general purpose architecture for modeling many structured domains. Perhaps more so than other architectures, the transformer empirically seems to have inductive biases that make it especially amenable to scaling, which has led to a paradigm in which larger versions of smaller, existing models are trained and released on a periodic basis. New instances of such models are typically trained completely from scratch, despite the fact that they are often scaled-up versions of their smaller counterparts. Given the compute required to train even the smaller models, it is argued that training each model from scratch is wasteful, and that prior knowledge implicit in the parameters of smaller, extant models should be leveraged to enable faster training of larger models.

Noting the empirical effectiveness of such recipes, it is observed that existing mechanisms generally do not have a learning component (e.g., randomly copying over neurons for width-expansion or stacking consecutive layers for depth-expansion). In one example embodiment, an efficient, data-driven approach for learning to grow transformers is utilized. In particular, the disclosed Learning to Grow (LIGO) approach frames the problem of initializing the larger model's parameters as learning a linear mapping from the smaller model's parameters, i.e., θ^{(large)}=Mθ^{(small)} where θ^{(small)} and θ^{(large)} are the vectorized parameters of the small and large models, respectively. Of course, this mapping is completely intractable to learn without any restrictions on M. The linear mapping is thus factorized to be a composition of sparse width- and depth-expansion operators, M=L_{depth}R_{width}, where both width and depth matrices are further factorized to be a Kronecker product of smaller matrices that express architectural knowledge (e.g., through grouping parameters by layers and neurons). It is shown that exemplary growth operators disclosed herein can represent existing approaches, such as layer-stacking and neuron-copying, as special cases. We have found that with a small amount of learning on M (e.g., 100 gradient steps) to initialize the larger model, training can be significantly accelerated and existing approaches can be outperformed for model growth with both vision and language transformers.

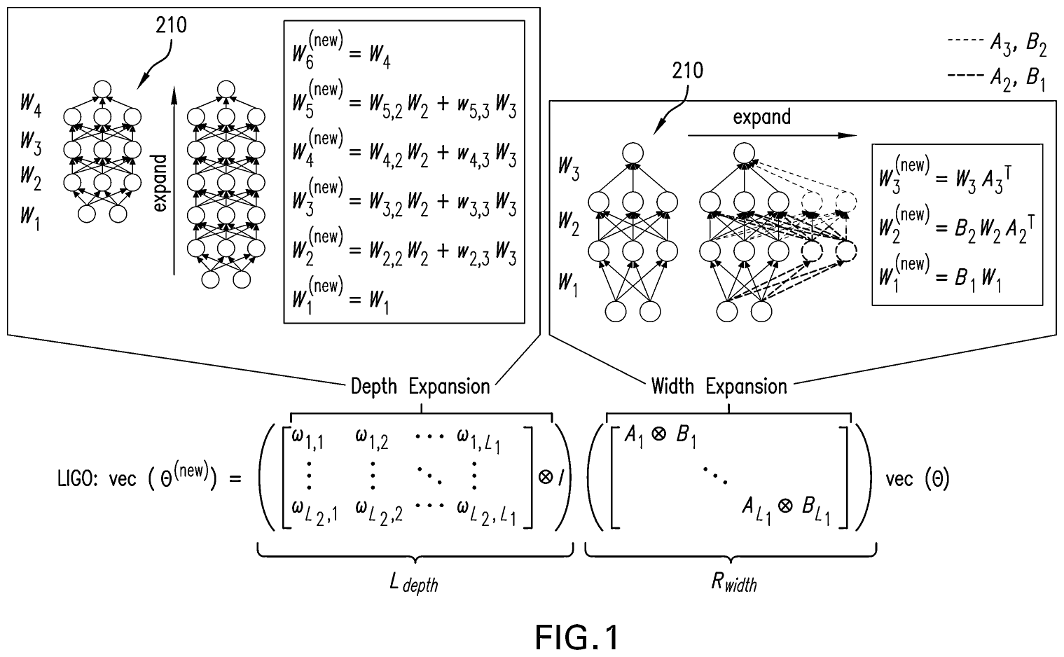

FIG. 1 is a block diagram of the learning to grow (LIGO) framework that accelerates training by using the weights 210 of a smaller model O to initialize the weights of the larger model θ^{(new)}, in accordance with an example embodiment. The LIGO operator is parameterized as a sparse linear map M that can be decomposed into width- and depth-expansion operators. The width-operator R_{width} and depth-operator L_{depth} are structured matrices obtained from Kronecker products of smaller matrices which encode architectural knowledge by grouping parameters into layers and neurons. While the expansion operators are shown for simple multi-layer perceptrons for illustrative purposes, in practice, LIGO is applied to enable faster training of transformer networks. In example embodiments, the LIGO matrix M is learned with 100 steps of stochastic gradient descent (SGD) and is used to initialize the larger model, and then training is continued as usual.

Extensive experiments on BERT, the robustly optimized BERT approach (RoBERTa), generative pretrained transformer, and a vision transformer (ViT) show that LIGO can consistently improve transformer training efficiency over the traditional way of training from scratch across domains and model sizes. For instance, LIGO saves 44.7% and 22.5% FLOPs for training BERT-Base and the conventional large language model from scratch by reusing pretrained smaller models that are half as big. Similarly, for vision transformers, when using a baseline conventional image transformer technique for initialization, LIGO yields 55% savings in FLOPs with no performance drop on a first conventional image training database. These FLOPs savings directly translate to similar savings in wall time (also known as elapsed time). It is also found that models trained using the disclosed approach achieve very similar performance compared to the trained-from-scratch baselines when transferred to other downstream tasks (e.g., language models and second and third conventional image training databases for vision models).

### Notation

The parameters of a neural network with L layers and D dimensions are denoted as θ_{L,D}=[W₁ . . . W_{L}]^{T}∈ [symbol] ^{LD×D}, where Wₗ∈ [symbol] ^{D×D} denotes the weights for the l-th layer. (For notational brevity, it is assumed that each hidden layer has the same number of dimensions D, but LIGO can be straightforwardly generalized to layers with different dimensions (e.g., feedforward neural (FFN) layers of transformers).) With slight abuse of notation, the vectorization of θ_{L,D} is denoted as vec(θ_{L,D})^{T}=[vecW₁^{T} . . . vecW_{L}^{T}]. (Therefore, vec(θ_{L,D})^{T}∈ [symbol] ^{LD}^{²}). Example embodiments are also agnostic with regard to vectorization order.) A goal of one or more embodiments, then, is to re-use the parameters θ=θ_{L,D} from a pretrained smaller model to initialize a large model θ^{(new)}=θ_{L}_{₂} _{,D}_{₂}, through a model growth operator M: [symbol] ^{L}^{₁}^{D}^{₁}^{×D}^{₁}→ [symbol] ^{L}^{₂}^{D}^{₂}^{×D}^{₂} that maps the weights of the smaller network to the weights of the larger one: θ^{(new)}=M(θ), where L₁<L₂ and D₁<D₂. After model growth, θ^{(new)} is adopted as the initialization of the large model and the large model is trained following standard recipes.

### Learning to Grow

While existing operators have been empirically successful in accelerating transformer-based models such as BERT, it has been observed that the existing operators generally do not have a learning component and perform the depth-and width-expansions separately. The present embodiments include a general framework for Learning to Grow (LIGO) pretrained models, which generalizes existing operators by combining the width- and depth-growth operators in a data-driven way.

The problem of initializing the weights of the larger model θ^{(new)} from the smaller model θ can be formulated through the following optimization problem,

$$arg {min}_{M} {x \sim}_{} ( x ; {Θ}^{( n e w )} ) , subject to {Θ}^{( n e w )} = M ( Θ ) , \qquad ( 1 )$$

where [symbol] is the data distribution. It is of course intractable to optimize over the entire operator space and, thus, the function M is further simplified to be a linear transformation, which results in the following formulation,

$$v ec ( {Θ}^{( n e w )} ) = v e c ( M ( Θ ) ) = M v ec ( Θ ) , M ∈ {{L}_{2} {D}_{2}^{2} \times {L}_{1} {D}_{1}^{2}}^{} \qquad ( 2 )$$

This simplified objective is still completely infeasible to apply to contemporary neural networks where L₁D₁ can easily be in the hundreds of millions. One or more embodiments advantageously provide an efficient parameterization of M for tractable learning.

### Decomposition Along Depth and Width

In one example embodiment, a first step is to decompose the LIGO operator as M=L_{depth}R_{width}, where L_{depth} and R_{width} expand the depth and width of the model separately. More concretely, M is decomposed as

$$M = [ \begin{matrix}diag ( {1 , 1}_{} ) & … & diag ( {1 , {L}_{1}}_{} ) \\ ⋮ & ⋱ & ⋮ \\ diag ( {{L}_{2} , 1}_{} ) & … & diag ( {{L}_{2} , {L}_{1}}_{} )\end{matrix} ] [ \begin{matrix}{R}_{1} & & \\ & ⋱ & \\ & & {R}_{{L}_{1}}\end{matrix} ] , \qquad ( 3 )$$

where Rₗ∈ [symbol] ^{D}^{₂}^{²} ^{×D}^{₁}^{²} and [symbol] _{i,j}∈ [symbol] ^{D}^{₂}^{²}. L_{depth} is an array of diagonal matrices and R_{width} is a block-diagonal matrix, i.e., both matrices are highly structured and sparse. When applying R_{width} to weights vec(θ), the parameters of each layer will be transformed independently via vec(Wₗ^{(new)})=Rₗvec(Wₗ) and lifted to a higher dimension. The/-th row block of L_{depth} corresponds to a growth operator of the l-th layer, which amounts to linearly combining all layers of the smaller model via vec

$${( {W}_{l}^{( n e w )} )}_{k} = {\sum }_{{l}^{′}}^{{L}_{1}} {( {l , {l}^{′}}_{} )}_{k} v e {c ( {W}_{l} )}_{k} .$$

By this factorization, the complexity of the LIGO operator can be effectively reduced from [symbol] (D₁²L₁D₂²L₂) to [symbol] (D₁²D₂²L₁) and the architectural knowledge encoded by grouping parameters by layers. It is shown below that this representation still enjoys high representation power due to its connection with Monarch matrices.

### Parameter Sharing via Kronecker Factorization

In one or more embodiments, the above LIGO operator still requires [symbol] (D₁²D₂²L₁) parameters for R_{width} and [symbol] (L₁L₂D₂²) for L_{depth}. The width operator R_{width} in this case still remains prohibitively expensive given that D₁ (and D₂) can easily be in the hundreds or thousands. A Kronecker factorization is therefore described to further reduce the number of learnable parameters for each growth operator.

### Depth

For depth, an entire layer is treated as a single group and a new layer is constructed by combining existing layers, effectively tying parameters for all neurons in the same layer. Formally, each block in L_{depth} is simplified to be diag( [symbol] _{i,j})=w_{i,j}I. Then the entire matrix can be written as a Kronecker factorization, L_{depth}=w⊗I, where w∈ [symbol] ^{L}^{₂}^{×L}^{₁} is a matrix whose entry w_{i,j} indicates blending weights of the j-th layer of the small model to form the i-th layer of the large model. This strategy reduces the number of parameters in L_{depth} to [symbol] (L₁L₂), and is shown on the left-hand side of FIG. 1.

### Width

For width, each diagonal block of the width expansion operator R_{width} is decomposed using the Kronecker factorization Rₗ=Aₗ⊗Bₗ, where Aₗ, Bₗ∈ [symbol] ^{D}^{₂}^{×D}^{₁}. Since vec(CAB)=(B^{T}⊗C)vec(A), then

$${R}_{w i d t h} v ec ( Θ ) = [ \begin{matrix}{A}_{1} ⊗ {B}_{1} & & \\ & ⋱ & \\ & & {A}_{{L}_{1}} ⊗ {B}_{{L}_{1}}\end{matrix} ] vec ( Θ ) \qquad ( 4 )$$

$$= vec ( {[ {B}_{1} {W}_{1} {A}_{1}^{T} … {B}_{{L}_{1}} {W}_{{L}_{1}} {A}_{{L}_{1}}^{T} ]}^{T} ) . \qquad ( 5 )$$

Here it is observed that BₗWₗAₗ^{T} performs in- and out-dimension expansion by Aₗ and Bₗ, respectively. Each new column/row is a linear combination of columns/rows of the small model's weight matrix. This factorization, which can be seen as grouping parameters by neurons, reduces the number of parameters to [symbol] (L₁D₁D₂). FIG. 1 (right-side) illustrates LIGO's width-expansion operator.

Altogether, the final parameterization of the LIGO operator M is obtained as:

$$M = ( [ \begin{matrix}\begin{matrix}{w}_{1 , 1} \\ ⋮ \\ {w}_{{L}_{2} , 1}\end{matrix} & \begin{matrix}{w}_{1 , 2} & … & {w}_{1 , {L}_{1}} \\ ⋮ & ⋱ & ⋮ \\ {w}_{{L}_{2} , 2} & … & {w}_{{L}_{2} , {L}_{1}}\end{matrix}\end{matrix} ] ⊗ I ) ( [ \begin{matrix}{A}_{1} ⊗ {B}_{1} & & \\ & ⋱ & \\ & & {A}_{{L}_{1}} ⊗ {B}_{{L}_{1}}\end{matrix} ] ) \qquad ( 6 )$$

The factorization can be exploited to implement the LIGO operator (Eq. 6) efficiently. Concretely, factorization expands a model in three steps: (1) for each layer, inserting new rows by linearly combining existing rows by Bₗ, (2) for each layer, inserting new columns by linearly combining existing columns by Aₗ and then, finally (3) reconstructing each layer by linearly combining the weight matrices with w along the depth. A few steps (e.g., 100 iterations) of SGD is run to optimize M, which has negligible compute cost relative to regular training. After obtaining M, the large model is initialized with M vec(θ), and parameters θ^{(new)} are trained through SGD as usual.

### Growing Transformers with LIGO

While LIGO can be applied to any multi-layer neural network architecture, one present focus is on using LIGO to grow transformers which have been shown to be particularly amenable to scaling.

### Embedding Layer

The embedding layer can be regarded as a linear layer whose inputs are one-hot embeddings. A learnable matrix B^{(emb)} is drawn to extend its output dimension. This embedding layer is also used as the final output layer for the present transformer language modeling experiments.

### Attention and Feedforward Layers

An attention layer includes multi-head attention weights (W^{Q}, W^{K}, W^{V}) and a linear projection (W^{O}). Let Aₗ^{k} and Bₗ^{k}, where k∈{Q, K, V, O}, be the in- and out-dimension expansion matrices (Eq. 4) for query, key, value, and projection in the l-th layer, respectively. To ensure the new input and output channels are aligned across modules, the LIGO operator is tied as follows: (1) Aₗ^{k}=B^{(emb)}^{^{T}} for ∀k∈{Q, K, V}, (2) Aₗ^{O}=(Bₗ^{V}^{^{T}}), (3) Bₗ^{O}=B^{(emb)} for ∀l ∈[L₁], among which the last constraint is added to take into account residual connections. Parameters for the feed-forward networks are similarly tied. Specifically, it is ensured that Aₗ^{(fc1)}=B^{(emb)T}, Aₗ^{(fc2)}=Bₗ^{(fc1)T} and Bₗ^{(fc2)}=B^{(emb)}. Both Bias terms and layer normalization inherit the associated linear transformations' out-dimension expansion matrices to grow the width. For depth expansion, each module independently combines the same module from other layers with learnable coefficients w. In some embodiments, each attention block is followed by a two-layer feed forward network.

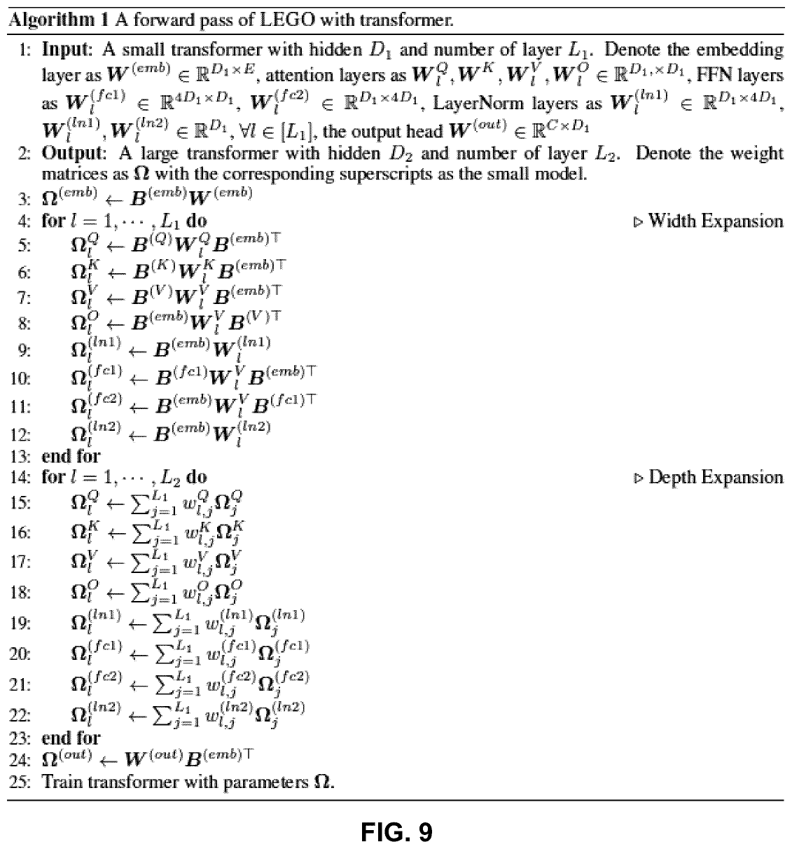

Since transformers make heavy use of residual layers with skip connections, it was found that simply using the same B^{(emb)} to parameterize Aₗ^{k} and Bₗ^{k} for many layers/modules worked well in practice. This reduces the number of learnable parameters even further and enables fast learning of M on a small amount of data (e.g., 100 gradient steps). Refer also to the discussion of FIG. 9 below.

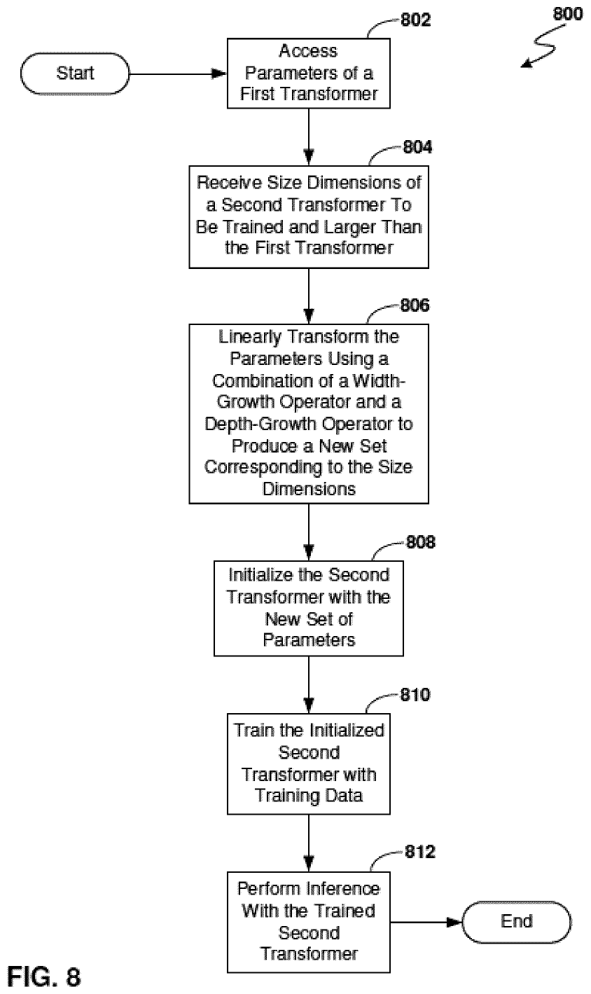

FIG. 8 is an example method for training a larger model using the weights of a smaller model and performing inferencing using the trained larger model, in accordance with an example embodiment. In one example embodiment, parameters of a first transformer are accessed (operation 802). Size dimensions of a second transformer to be trained and larger than the first transformer are received (operation 804). The parameters are linearly transformed using a combination of a width-growth operator and a depth-growth operator to produce a new set corresponding to the size dimensions (operation 806). The second transformer is initialized with the new set of parameters (operation 808) and the initialized second transformer is trained with training data (operation 810). Inferencing is performed with the trained second transformer (operation 812).

FIG. 9 is an example method for performing a forward pass using the learning to grow framework, in accordance with an example embodiment. Input to the forward passing method includes a small transformer with hidden D₁ and number of layers L₁, where the embedding layer is denoted as W^{(emb)}∈ [symbol] ^{D}^{₁}^{×E}, the attention layers are denoted as Wₗ^{Q}, W^{K}, Wₗ^{V}, Wₗ^{O}∈ [symbol] ^{D}^{₁}^{×D}^{₁}. the FFN layers are denoted as Wₗ^{(fc1)}∈ [symbol] ^{4D}^{₁}^{×D}^{₁}, Wₗ^{(fc2)}∈ [symbol] ^{D}^{₁}^{×4D}^{₁}, the LayerNorm layers are denoted as Wₗ^{(ln1)}∈ [symbol] ^{D}^{₁}^{×4D}^{₁}, Wₗ^{(ln1)}, Wₗ^{(ln2)}∈ [symbol] ^{D}^{₁}, ∀l∈[L₁], and the output head is denoted as W^{(out)}∈ [symbol] ^{C×D}^{₁}. The output includes a large transformer with hidden D₂ and number of layers L₂, where the weight matrices are denoted as Ω with the corresponding superscripts as the small model.

In one example embodiment, the weight matrices Ω are initialized based on the embedding layer W^{(emb)} and a learnable matrix B^{(emb)}. Width expansion is performed for each layer of the transformer followed by depth expansion for each layer of the transformer. The output embeddings Ω^{(out)} are then generated based on the generated output head W^{(out)} and the learnable matrix B^{(emb)}. The transformer is then trained with the parameters Ω.

### Connection to Monarch Matrices

As shown in the section entitled “Decomposition along depth and width,” exemplary depth-width decomposition as disclosed herein factorizes M into a multiplication of two structured sparse matrices. The expressiveness of this factorized representation is examined by relating it to Monarch matrices, defined below.

Definition 1. Let the space of Monarch matrices be [symbol] ⊆ [symbol] ^{mn}^{₁}^{×mn}^{₂}. Then, matrix M∈ [symbol] if M=P₁LP₂^{T}R=P₁diag(L₁, . . . , Lₙ_{₁},)P₂^{T} diag(R₁, . . . , Rₙ_{₂}) where Lᵢ∈ [symbol] ^{b}^{₁}^{×b}^{₂}, Rᵢ∈ [symbol] ^{b}^{₃}^{×b}^{₄} are dense rectangular matrices, and n₁b₂=n₂b₃. P₁ is the permutation

$$π ( i ) = ( i - {b}_{1} ⌊ \frac{i}{{b}_{1}} ⌋ - 1 ) {n}_{1} + ⌊ \frac{i}{{b}_{1}} ⌋ + 1$$

and P₂ is the permutation

$$π ( j ) = ( j - {b}_{2} ⌊ \frac{i}{{b}_{2}} ⌋ - 1 ) {n}_{1} + ⌊ \frac{i}{{b}_{2}} ⌋ + 1 .$$

It is clear that the block-diagonal matrix R has the identical form to the disclosed width growing operator R_{width}. By applying the permutation matrices P₁ and P₂ to L, L is transformed into the exactly the same form with the disclosed depth-growth operator L_{depth} in Eq. 3. This implies that the disclosed depth-width decomposition coincides with Monarch sparsification of dense matrices, which generalize butterfly matrices and enjoy rich expressivity properties.

### Experiments

Experiments were conducted to answer three pertinent questions. Q1: To what extent LIGO can improve the training efficiency (FLOPs and wall time) of transformers compared to training from scratch and other growth operators? Q2: Can LIGO be universally effective across transformers from different domains (e.g., language and vision) and sizes? Q3: Can models trained using LIGO achieve similar performance compared to the baselines when transferred to other downstream tasks?

### Experimental Setup

Datasets. An English corpus was used for training BERT and a public dataset was used for training the conventional large language model. The first conventional image database was used for training the vision transformers. The first conventional sentence classification benchmark (FCSCB), a first reading comprehension dataset (FRCD), and a second reading comprehension dataset (SRCD) were used for evaluating pretrained BERT models. The downstream performance of vision transformers was tested by performing transfer learning on five downstream image classification tasks.

Models. Experiments were conducted with transformers of different sizes under the following settings: (1) BERT-Small→BERT-Base, BERT-Base→BERT-Large, BERT-Small→BERT-Large for BERT, (2) RoBERTa-Small→RoBERTa-Base for RoBERTa, (3) the conventional large language model-Medium→the conventional large language model-Large for the conventional large language model, and (4) a baseline conventional image transformer technique-S→ a baseline conventional image transformer technique-B for vision transformer. (BERT-Small has 6 layers with 512 hidden dimensions, while the other named models are their usual sizes.)

Baselines. Example embodiments were compared with the following baselines: (1) a training from scratch baseline where the larger transformer was trained without using any smaller pretrained models, (2) progressive training methods designed for growing depth in transformers, (3) bert2BERT that extends the second conventional technique for width expansion and stacking for depth expansion, and (4) knowledge inheritance (KI) which uses distillation for transferring knowledge from the smaller model to the larger model.

### Exemplary Implementation Details

In experiments, 100 gradient steps were used to learn the LIGO operator for all models, which is negligible in terms of FLOPs/wall time compared to full training after initialization. Both BERT and RoBERTa models were trained for 400 K steps with a warmup of 10 K steps. The next-sentence prediction task was removed and a fixed sequence length of 128 was used for pretraining both models. For BERT, a batch size of 256 and a learning rate of 2×10⁻⁴ were used, while a batch size of 1024 and a learning rate of 8×10⁻⁴ were used for training RoBERTa models. The conventional large language model models were trained with a batch size of 384 and sequence length of 1024. For the vision transformer, the models were built based on the baseline conventional image transformer technique, and their default hyper-parameters were applied for training on the first conventional image database. All the vision transformers were trained for 300 epochs with a batch size of 1024. For transfer learning with BERT/RoBERTa, training was performed for 3 epochs with a learning rate of 1e⁻⁴ and a batch-size of 32 for all tasks in the first conventional sentence classification benchmark. On the first reading comprehension dataset and the second reading comprehension dataset, fine-tuning was performed for 2 epochs with a learning rate of 5e⁻⁵ and a batch size of 12. Both the first conventional sentence classification benchmark and the reading comprehension dataset evaluations were run three times with different random seeds and the mean numbers were reported. For transfer learning experiments on the baseline conventional image transformer technique, the pretrained models were fine-tuned with 1000 epochs, batch size 768, and learning rate 0.01, and the same data augmentation in training on the first conventional image training database was used. The same pretraining data and experimental settings were used for all the baselines (including the disclosed approach) for a fair comparison.

### Results and Analysis

### BERT

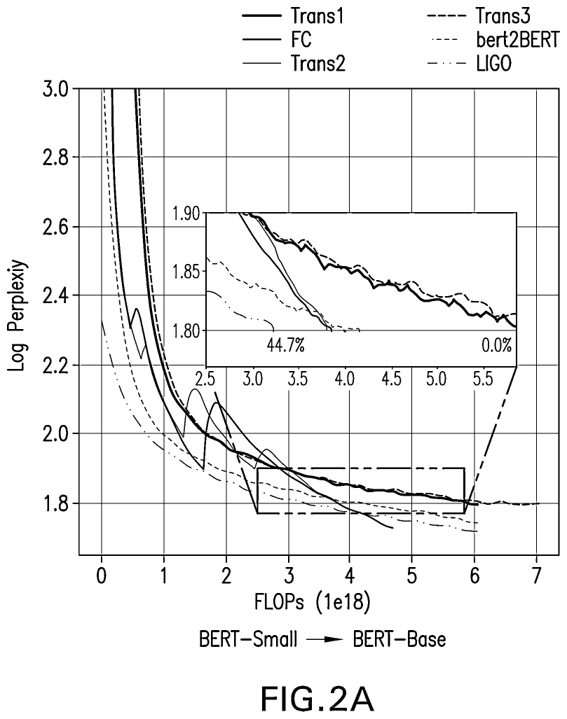

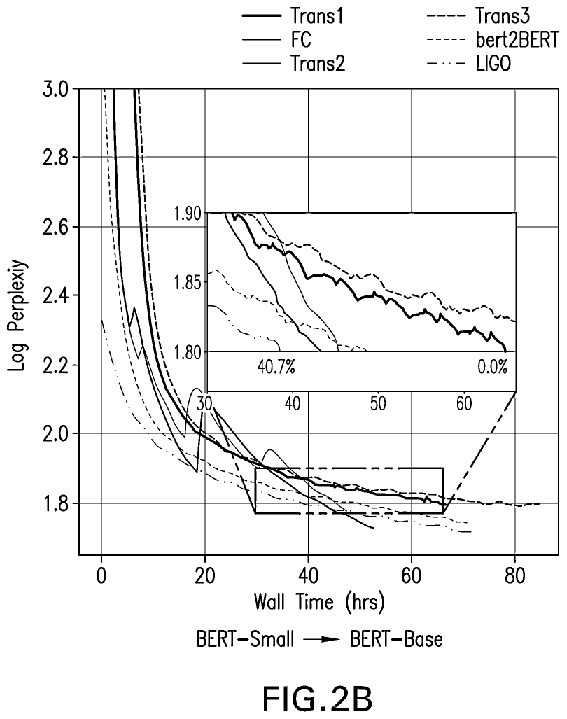

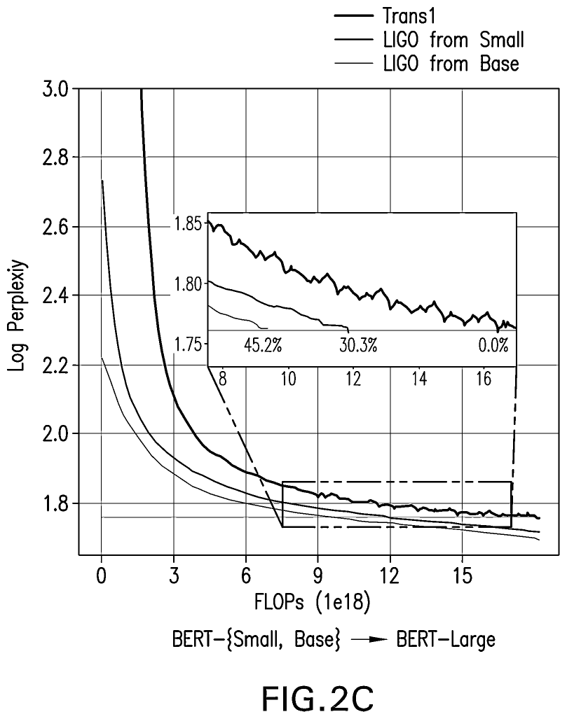

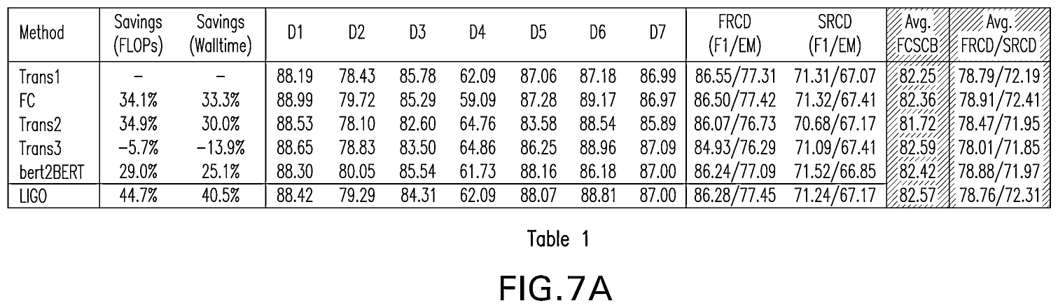

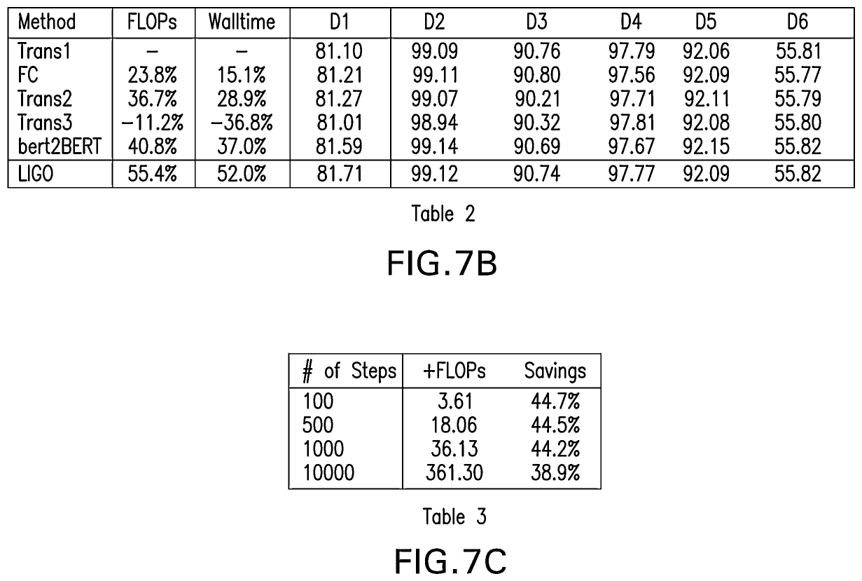

FIGS. 2A-2C show comparisons between the different baselines for training BERT models, in accordance with example embodiments. FIGS. 2A-2B show validation log perplexity vs. FLOPs and wall time respectively, for different methods in training BERT-Base by reusing BERT-Small of almost half of the size; and FIG. 2C shows log perplexity vs. FLOPs in growing BERT-Small and BERT-Base to BERT-Large. LIGO offers about a 45% savings in FLOPs and a 40% savings in wall time over the BERT-Base training from scratch. Example embodiments are also flexible in reusing either BERT-Small or BERT-Base for accelerating BERT-Large training. FIGS. 7A-7C shows tables of experimental results, in accordance with example embodiments. Table 1 of FIG. 7A shows the downstream performance on the first conventional sentence classification benchmark and the reading comprehension datasets. All of the results are based on BERT-Base models trained using different baselines. LIGO achieves similar or even better performance than the original training from scratch baseline on several downstream tasks, despite improving training efficiency. As seen from FIG. 2(a), LIGO saves 44.7% computational cost (FLOPs) of training BERT-Base (12 layers, 768 dimensions) from scratch by reusing BERT-Small (which is almost half of the size). On the same setting, LIGO offers a 40.7% savings in wall time compared to training from scratch (FIG. 2B). Among the compared methods, first conventional technique is the most competitive in terms of both FLOPs and wall time. However, the disclosed data-driven approach to growth obtains +10.6% and +7.2% improvements in FLOPs and wall time on top of first conventional technique. Similarly, LIGO significantly outperforms the recent bert2BERT method which saves about 30% computational costs. It was observed that KI does not provide any real savings in training as it requires additional computation for knowledge distillation. Furthermore, FIG. 2C shows that the LIGO approach is flexible in growing either BERT-Small or BERT-Base for accelerating BERT-Large training. As expected, reusing BERT-Base instead of BERT-Small leads to 14.9% more savings in FLOPs (45.2% vs 30.3%) as BERT-Base contains more implicit knowledge in its parameters. Finally, Table 3 of FIG. 7C shows the per-task performance of different BERT-Base models on both the first conventional sentence classification benchmark and the reading comprehension benchmarks. Despite being trained significantly faster than scratch, BERT trained with the LIGO approach achieves very similar performance compared to the baselines on both benchmarks.

### RoBERTa and the Conventional Large Language Model

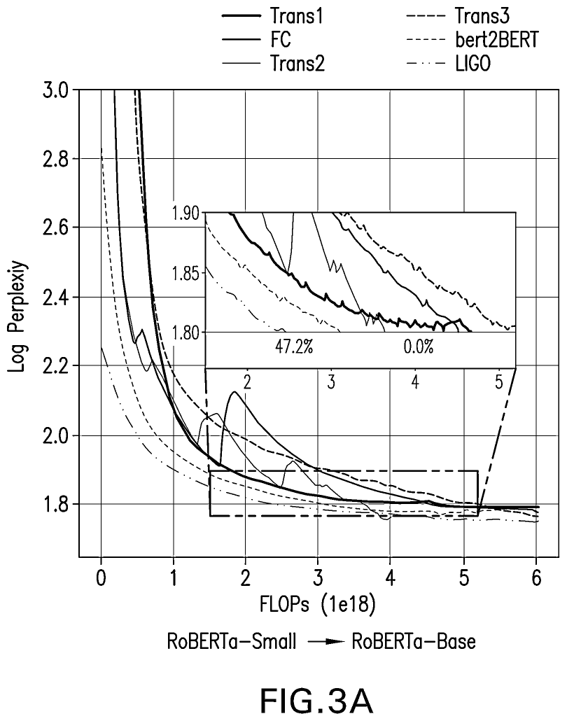

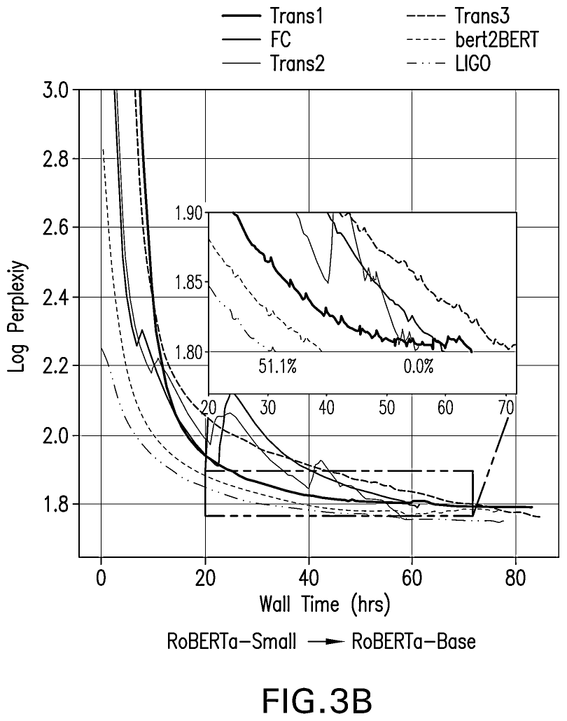

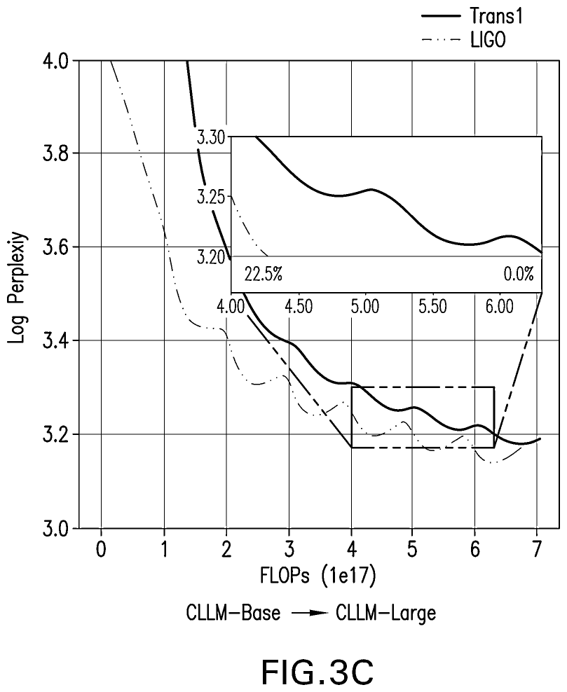

FIGS. 3A-3C shows results on RoBERTa and the conventional large language model, in accordance with example embodiments. LIGO reduces FLOPs by 47.2% and 22.5% for RoBERTa-Base and the conventional large language model-Large training, demonstrating its effectiveness across different training strategies and architectures. FIG. 3A-3B show the results on RoBERTa, whose training recipe uses a larger batch size and learning rate than BERT. LIGO similarly accelerates RoBERTa training, which indicates that the LIGO approach is robust to optimization hyperparameters. On the conventional large language model, the LIGO approach saves 22.5% computation cost of training the conventional large language model-Large (774M parameters) by reusing the conventional large language model-Medium (345M parameters) (see FIG. 3C). (Due to the extensive resources required to train the conventional large language model-Large, the other baseline growth operators were not run on the conventional large language model experiments. Note that these existing growth operators, for the most part, had been exclusively applied to BERT-style encoders.) These consistent improvements illustrate that the LIGO approach is effective for accelerating training of transformers across different model architectures and sizes.

### Vision Transformer

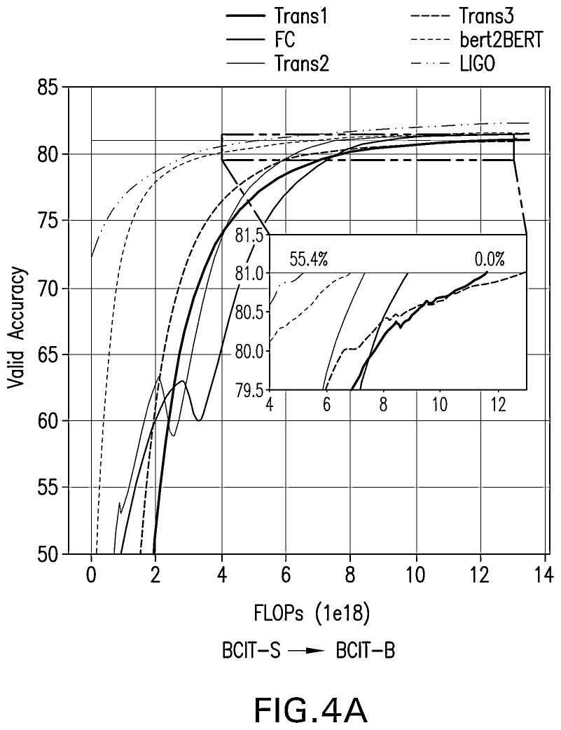

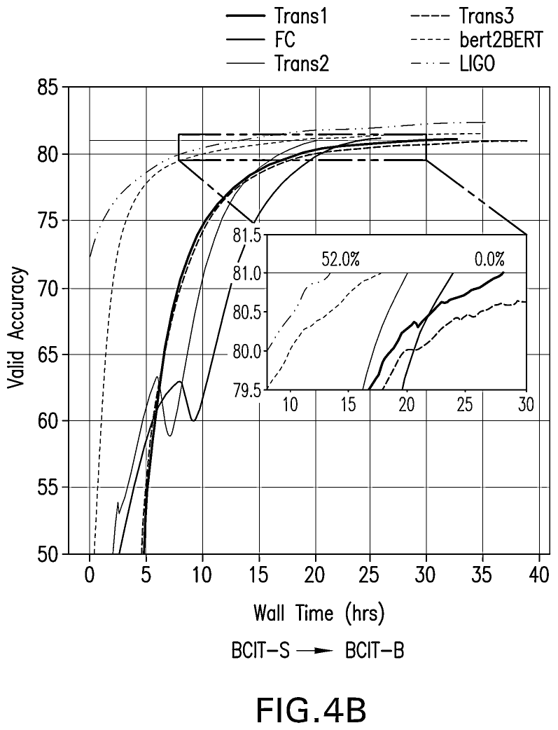

FIGS. 4A-B show results on the baseline conventional image transformer technique for image classification tasks, in accordance with example embodiments. FIG. 4A shows accuracy vs. flops and FIG. 4B shows accuracy vs. wall time, for training the baseline conventional image transformer technique. LIGO saves flops and wall time by more than 50% over training from scratch on the first conventional image training database. Table 2 of FIG. 7B shows transfer learning performance of the baseline conventional image transformer technique. Despite being trained twice as fast, the baseline conventional image transformer technique-B models trained using LIGO are very competitive with original training from scratch baseline on all downstream tasks. FIGS. 4A-4B show that by using the baseline conventional image transformer technique, LIGO can save 55.4% FLOPs and 52% GPU wall time to reach the same performance of 81% on the first conventional image training database. Interestingly, the model initialized by the disclosed data-driven growth operator (with only 100 gradient steps of tuning) can already achieve 72% accuracy at the beginning of training and leads to the final accuracy of 81.7% at the end of the training. Compared to the next best method, bert2BERT, LIGO obtains more than 15% savings, which once again demonstrates the effectiveness of the LIGO approach in growing vision transformers as well. Table 2 of FIG. 7B shows that fine-tuning results on downstream tasks are also on-par performance with models trained from scratch, showing that LIGO does not harm the model generalization capability when transferred to downstream datasets.

### Combining with Other Training Strategies

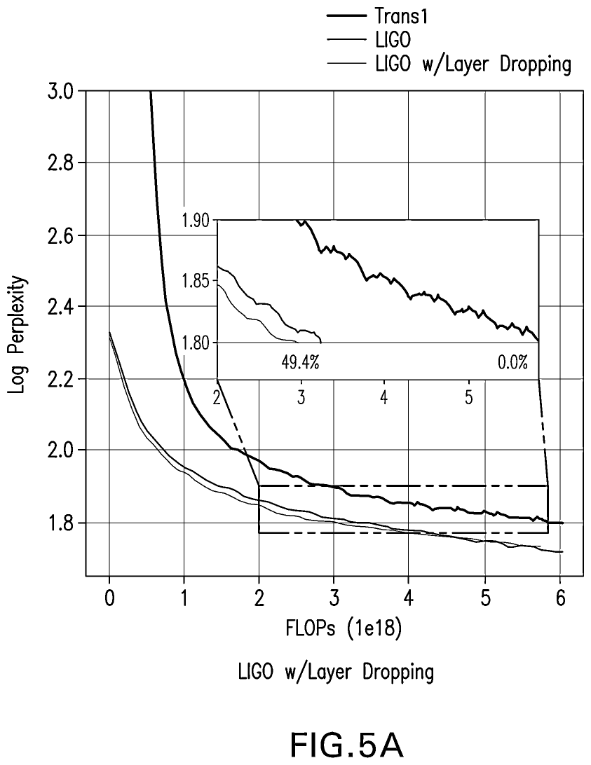

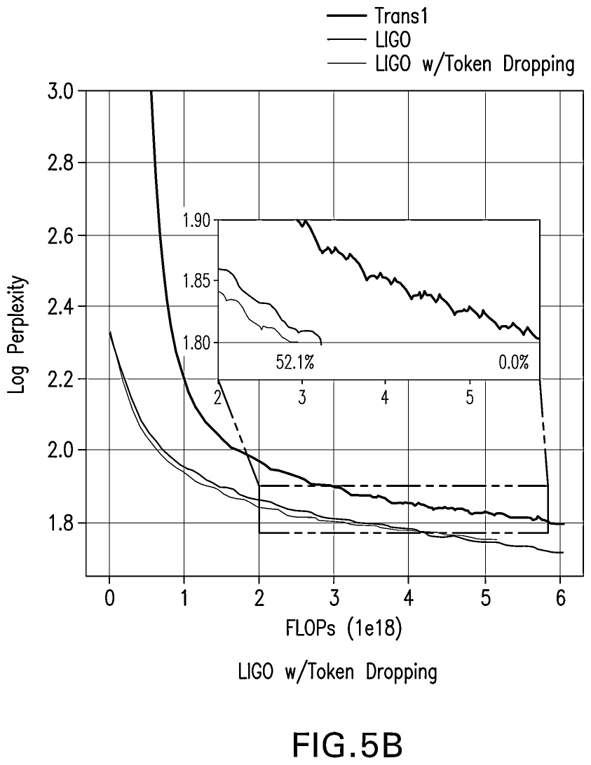

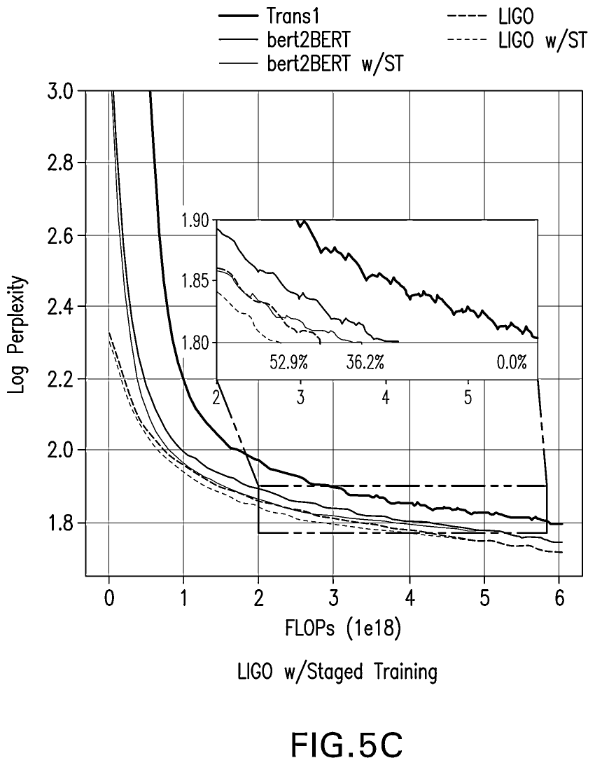

It was also validated that the LIGO approach can be effectively combined with other orthogonal strategies, such as layer dropping, token dropping, and staged training. FIGS. 5A-5C show results of applying LIGO with Orthogonal Training Strategies, in accordance with example embodiments. The disclosed approach can be combined with (a) layer dropping (FIG. 5A), (b) token dropping (FIG. 5B), and (c) staged training (ST) for further accelerating BERT training (FIG. 5C). FIGS. 5A-5C shows that LIGO can be combined with other training techniques to improve the computational savings by 4.7%, 7.4%, and 8.2% with layer dropping, token dropping and staged training, respectively. A staged training strategy was also applied to bert2BERT and it was observed that LIGO still outperforms bert2BERT with staged training by 16.7% (see FIG. 5C).

### Ablation Studies

### Depth Only Expansion

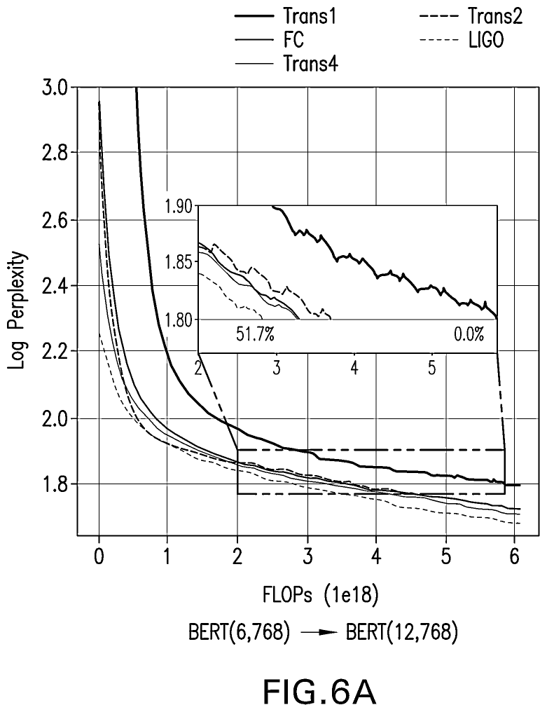

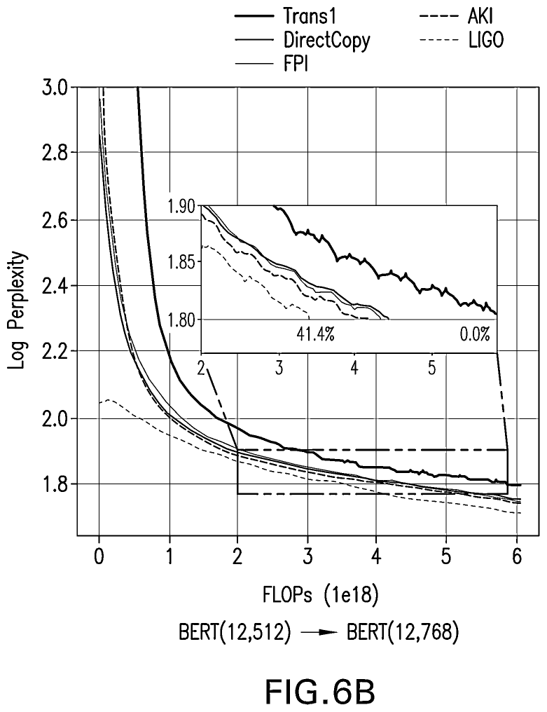

In this experiment, the effectiveness of the disclosed depth expansion operator (L_{depth}) was examined by only growing the depth of a BERT from 6 layers to 12 layers, i.e., (BERT(6, 768)→BERT(12, 768). The results were compared with stacking, and multi-stage layerwise training (MSLT). For LIGO, its L_{depth} component was only applied to the pre-trained model weights. FIGS. 6A-6B show the results on depth only and width only extension, in accordance with an example embodiment. LIGO saves computation cost by 51.7% and 41.6% over the original training from scratch, while extending only depth or width separately. Table 3 of FIG. 7C shows the effect of a number of gradient steps. “+FLOPs” stands for additional flops (in 1015). Results in FIG. 6A show that a data-driven approach works well even when just growing across the depth dimension. Results in FIG. 6B show that a data-driven approach works well even when just growing across the width dimension.

### Width Only Expansion

The effectiveness of R_{width} was also verified by only extending BERT width from 512 to 768, i.e., (BERT(12, 512)→BERT(12, 768). LIGO based initialization was compared with direct copy, function preserving initialization, and advanced knowledge initialization. LIGO's width expansion component outperforms all other methods, as shown in FIG. 6(b).

### Learning Steps

All experiments just used 100 gradient steps to grow. The LIGO operator was tuned on the pretraining set for 100, 500, 1000, and 10000 steps and the additional FLOPs were computed for BERT-Small→BERT-Base training. Table 3 of FIG. 7C shows that training LIGO operator within 1000 steps results in the identical model convergence (reaching 1.8 PPL at 215 K steps). This suggests tuning model weights under the linear constraints of LIGO can achieve a faster convergence than conventional techniques. Training the LIGO operator for more than 10,000 steps can provide a model with slightly faster convergence (214 K steps), but results in less savings overall.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
a framework for improving transformer training efficiency over the conventional way of training transformers from scratch across domains and model sizes;
approximate 50% savings of computational cost for training a machine learning model, such as a transformer, from scratch to perform language and vision tasks, while also consistently outperforming baseline techniques that also reuse smaller, pretrained models to initialize larger models;
improve the technological process of machine learning by leveraging the prior knowledge implicit in the parameters of smaller, extant models for enabling faster training of larger models;
savings of 44.7% and 22.5% floating-point operations (FLOPs) for training Bidirectional Encoder Representations from Transformers (BERT)-Base and a conventional large language model (CLLM) from scratch by reusing pretrained smaller models that are half as large; and
for vision transformers, when using a baseline conventional image transformer (BCIT) technique for initialization, a 55% savings in FLOPs with no performance drop on a first conventional image training database, with FLOPs savings that directly translate to similar savings in wall time (also known as elapsed time), while achieving very similar performance compared to trained-from-scratch baselines (when transferred to other downstream tasks).

Given the discussion thus far, it will be appreciated that, in general terms, an exemplary method, according to an aspect of the invention, includes the operations of accessing parameters of a first transformer (operation 802); receiving size dimensions of a second transformer that is to be trained and is larger than the first transformer (operation 804); linearly transforming the parameters of the first transformer using a combination of a width-growth operator and a depth-growth operator, wherein the linear transformation produces a set of new parameters, the set corresponding to the size dimensions of the second transformer (operation 806); and initializing the second transformer with the set of new parameters (operation 808).

In one example embodiment, the initialized second transformer is trained with training data to produce a trained second transformer (operation 810); and inferencing is performed via the trained second transformer (operation 812).

In one example embodiment, the inferencing comprises performing natural language processing to control a device via a network interface.

In one example embodiment, the combination of the width-growth operator and the depth-growth operator is a multiplication.

In one example embodiment, the width-growth operator comprises a block-diagonal matrix and the depth-growth operator comprises an array of diagonal matrices.

In one example embodiment, both the array of diagonal matrices and the block-diagonal matrix are sparse.

In one example embodiment, the depth-growth operator linearly combines all layers of the first transformer and, via a factorization, groups the parameters of the first transformer by the layers.

In one example embodiment, a Kronecker factorization is applied to the width-growth operator and to the depth-growth operator to reduce a respective number of learnable parameters of the width-growth operator and of the depth-growth operator.

In one example embodiment, for the depth-growth operator, an entire layer is treated as a single group, a new layer is constructed by combining existing layers, and parameters for all neurons within a single layer are tied in a same layer.

In one example embodiment, for the width-growth operator, the parameters of the first transformer are grouped by neurons.

In one example embodiment, the linearly transforming the parameters of the first transformer comprises linearly transforming parameters of an embedding layer of the first transformer to produce extended parameters for an embedding layer of the second transformer.

In one example embodiment, the linearly transforming the parameters of the first transformer comprises using an embedding layer matrix to parameterize at least one of an attention layer and a feedforward layer of the second transformer.

In one example embodiment, the combination of the width-growth operator and the depth-growth operator is learned via steps of stochastic gradient descent.

In one example embodiment, a technique selected from the group consisting of layer dropping, token dropping, and staged training is performed.

In one aspect, a computer program product comprises one or more tangible computer-readable storage media and program instructions stored on at least one of the one or more tangible computer-readable storage media, the program instructions executable by a processor to cause the processor to perform operations comprising accessing parameters of a first transformer (operation 802); receiving size dimensions of a second transformer that is to be trained and is larger than the first transformer (operation 804); linearly transforming the parameters of the first transformer using a combination of a width-growth operator and a depth-growth operator, wherein the linear transformation produces a set of new parameters, the set corresponding to the size dimensions of the second transformer (operation 806); and initializing the second transformer with the set of new parameters (operation 808).

In one aspect, an apparatus comprises a memory and at least one processor, coupled to the memory, and operative to perform operations comprising accessing parameters of a first transformer (operation 802); receiving size dimensions of a second transformer that is to be trained and is larger than the first transformer (operation 804); linearly transforming the parameters of the first transformer using a combination of a width-growth operator and a depth-growth operator, wherein the linear transformation produces a set of new parameters, the set corresponding to the size dimensions of the second transformer (operation 806); and initializing the second transformer with the set of new parameters (operation 808).

One or more embodiments further include carrying out or otherwise facilitating deployment of the trained expanded artificial intelligence transformer. One or more embodiments further include carrying out (or otherwise facilitating) inferencing using the trained expanded artificial intelligence transformer.

In one example embodiment, parameters θ=θ_{L,D} from the pretrained transformer are reused to initialize the expanded artificial intelligence transformer θ^{(new)}=θ_{L}_{₂}_{,D}_{₂} via a model growth operator M: [symbol] ^{L}^{₁}^{D}^{₁}^{×D}^{₁}→ [symbol] ^{L}^{₂}^{D}^{₂}^{×D}^{₂} that maps weights of the pretrained transformer to initial weights of the expanded artificial intelligence transformer θ^{(new)}=M(θ), where L₁<L₂ and D₁<D₂, wherein the expanded artificial intelligence transformer is larger than the pretrained model; the initial weights of the expanded artificial intelligence transformer θ^{(new)} are adopted as an initial configuration of the expanded artificial intelligence transformer; wherein the training the expanded artificial intelligence transformer further comprises training the initial weights of the expanded artificial intelligence transformer; and wherein the carrying out of the inferencing comprises performing natural language processing using the trained expanded artificial intelligence transformer to control a device via a network interface (see FIG. 8, e.g.).

In one example embodiment, the learning the arrangement of the pretrained transformer further comprises learning a linear mapping of the weights of the pretrained transformer to determine the model growth operator M.

In one example embodiment, the learning the arrangement of the pretrained transformer further comprises factorizing the linear mapping as a composition of linear, sparse width- and depth-growth operators M=L_{depth}R_{width}; and a Kronecker factorization of the growth operators is employed to encode architectural knowledge of the pretrained transformer.

In one example embodiment, a first operator L_{depth} of the model growth operator comprises an array of diagonal matrices and a second operator R_{width} of the model growth operator comprises a block-diagonal matrix, and wherein both the array of diagonal matrices and the block-diagonal matrix are sparse. The skilled artisan is familiar with the definition of sparse matrices.

In one example embodiment, the model growth operator M comprises a depth-expansion operator in which the pretrained transformer is stacked with other pretrained models.

In one example embodiment, the model growth operator M comprises a depth-expansion operator in which the pretrained transformer is combined with identity layers and a width-expansion operator in which matrices of the pretrained transformer are copied to initialize matrices of the expanded artificial intelligence transformer.

In one example embodiment, a final parameterization of the model growth operator M is:

$$M = ( [ \begin{matrix}\begin{matrix}{w}_{1 , 1} \\ ⋮ \\ {w}_{{L}_{2} , 1}\end{matrix} & \begin{matrix}{w}_{1 , 2} & … & {w}_{1 , {L}_{1}} \\ ⋮ & ⋱ & ⋮ \\ {w}_{{L}_{2} , 2} & … & {w}_{{L}_{2} , {L}_{1}}\end{matrix}\end{matrix} ] ⊗ I ) ( [ \begin{matrix}{A}_{1} ⊗ {B}_{1} & & \\ & ⋱ & \\ & & {A}_{{L}_{1}} ⊗ {B}_{{L}_{1}}\end{matrix} ] ) .$$

In one example embodiment, the final parameterization defines a result where:
for each layer, new rows are inserted by linearly combining existing rows by Bₗ;
for each layer, new columns are inserted by linearly combining existing columns by Aₗ; and
each layer is reconstructed by linearly combining the weight matrices with w along a depth dimension.

In one aspect, a computer program product comprises one or more tangible computer-readable storage media and program instructions stored on at least one of the one or more tangible computer-readable storage media, the program instructions executable by a processor to cause the processor to access a pretrained transformer; access one or more parameters and neural connections associated with the pretrained transformer; learn, using a machine learning model, an arrangement of the pretrained transformer based upon the one or more parameters and neural connections associated with the pretrained transformer; train an expanded artificial intelligence transformer based on the learned arrangement; and, optionally, carry out inferencing using the trained expanded artificial intelligence transformer.

In one aspect, an apparatus comprises a memory and at least one processor, coupled to the memory, and operative to perform operations comprising accessing a pretrained transformer; accessing one or more parameters and neural connections associated with the pretrained transformer; learning, using a machine learning model, an arrangement of the pretrained transformer based upon the one or more parameters and neural connections associated with the pretrained transformer; training an expanded artificial intelligence transformer based on the learned arrangement; and, optionally, carrying out inferencing using the trained expanded artificial intelligence transformer.

Note that, in another aspect, an exemplary method, according to another aspect of the invention, includes the operations of accessing a pretrained transformer; accessing one or more parameters and neural connections associated with the pretrained transformer; learning, by a hardware computing device using a machine learning model, an arrangement of the pretrained transformer based upon the one or more parameters and neural connections associated with the pretrained transformer; and training an expanded artificial intelligence transformer based on the learned arrangement.

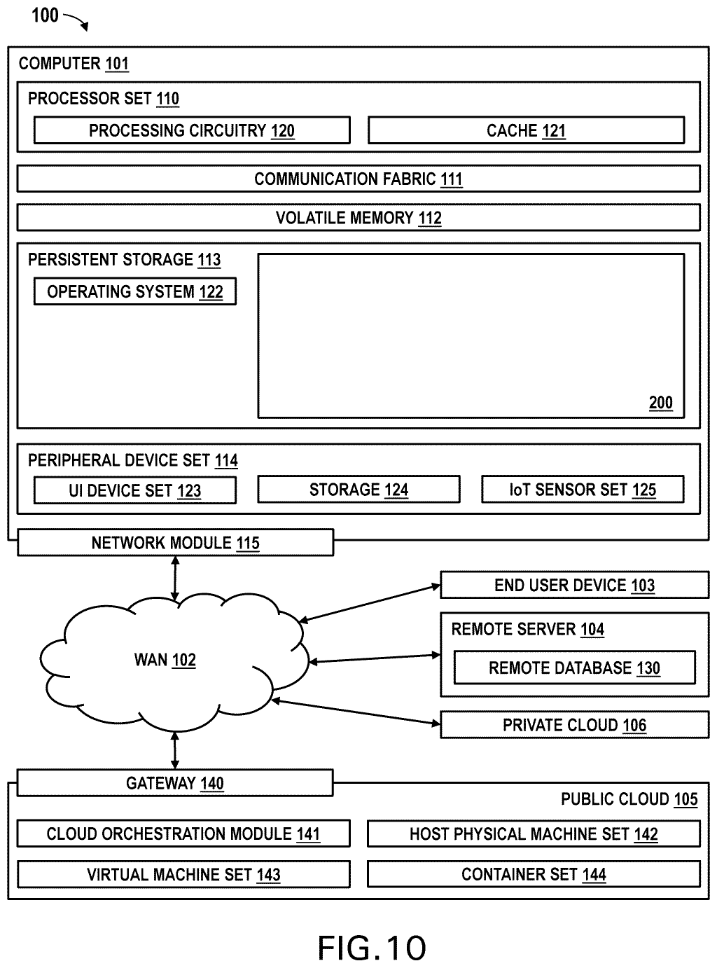

Refer now to FIG. 10.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code 200 implementing transformer training based on smaller pretrained model. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for machine learning training comprising:
accessing parameters of a first transformer;
receiving size dimensions of a second transformer that is to be trained and is larger than the first transformer;
linearly transforming the parameters of the first transformer using a combination of a width-growth operator and a depth-growth operator, wherein the linear transformation produces a set of new parameters, the set corresponding to the size dimensions of the second transformer; and
initializing the second transformer with the set of new parameters.

2. The method of claim 1, further comprising:
training the initialized second transformer with training data to produce a trained second transformer; and
performing inferencing via the trained second transformer.

3. The method of claim 2, wherein the inferencing comprises performing natural language processing to control a device via a network interface.

4. The method of claim 1, wherein the combination of the width-growth operator and the depth-growth operator is a multiplication.

5. The method of claim 1, wherein the width-growth operator comprises a block-diagonal matrix and the depth-growth operator comprises an array of diagonal matrices.

6. The method of claim 5, wherein both the array of diagonal matrices and the block-diagonal matrix are sparse.

7. The method of claim 1, wherein the depth-growth operator linearly combines all layers of the first transformer and, via a factorization, groups the parameters of the first transformer by the layers.

8. The method of claim 1, further comprising applying a Kronecker factorization to the width-growth operator and to the depth-growth operator to reduce a respective number of learnable parameters of the width-growth operator and of the depth-growth operator.

9. The method of claim 8, wherein, for the depth-growth operator, an entire layer is treated as a single group, a new layer is constructed by combining existing layers, and parameters for all neurons within a single layer are tied in a same layer.

10. The method of claim 8, wherein, for the width-growth operator, the parameters of the first transformer are grouped by neurons.

11. The method of claim 1, wherein the linearly transforming the parameters of the first transformer comprises linearly transforming parameters of an embedding layer of the first transformer to produce extended parameters for an embedding layer of the second transformer.

12. The method of claim 1, wherein the linearly transforming the parameters of the first transformer comprises using an embedding layer matrix to parameterize at least one of an attention layer and a feedforward layer of the second transformer.

13. The method of claim 1, wherein the combination of the width-growth operator and the depth-growth operator is learned via steps of stochastic gradient descent.

14. The method of claim 1, further comprising performing a technique selected from the group consisting of layer dropping, token dropping, and staged training.

15. A computer program product, comprising:
one or more tangible computer-readable storage media and program instructions stored on at least one of the one or more tangible computer-readable storage media, the program instructions executable by a processor, the program instructions comprising:
accessing parameters of a first transformer;
receiving size dimensions of a second transformer that is to be trained and is larger than the first transformer;
linearly transforming the parameters of the first transformer using a combination of a width-growth operator and a depth-growth operator, wherein the linear transformation produces a set of new parameters, the set corresponding to the size dimensions of the second transformer; and
initializing the second transformer with the set of new parameters.

16. A system comprising:
a memory; and
at least one processor, coupled to said memory, and operative to perform operations comprising:
accessing parameters of a first transformer;
receiving size dimensions of a second transformer that is to be trained and is larger than the first transformer;
linearly transforming the parameters of the first transformer using a combination of a width-growth operator and a depth-growth operator, wherein the linear transformation produces a set of new parameters, the set corresponding to the size dimensions of the second transformer; and
initializing the second transformer with the set of new parameters.

17. The system of claim 16, the operations further comprising:
training the initialized second transformer with training data to produce a trained second transformer; and
performing inferencing via the trained second transformer.

18. The system of claim 17, wherein the inferencing comprises performing natural language processing to control a device via a network interface.

19. The system of claim 16, wherein the depth-growth operator linearly combines all layers of the first transformer and, via a factorization, groups the parameters of the first transformer by the layers.

20. The system of claim 16, the operations further comprising applying a Kronecker factorization to the width-growth operator and to the depth-growth operator to reduce a respective number of learnable parameters of the width-growth operator and of the depth-growth operator.
